(19) United States
(12) Patent Application Publication
(10) Pub. No.: US 2007/0288255 A1
(43) Pub. Date: Dec. 13, 2007

(54) Method And Apparatus For Assigning Rack Space

(76) Inventors: Jun Cai, Shanghai (CN); Yi You, Shanghai (CN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/746,066

(22) Filed: May 9, 2007

(30) Foreign Application Priority Data
May 11, 2006 (CN) 200610026487.6

(51) Int. Cl. G06Q 10/00; G06Q 30/00; G05B 19/418

(52) U.S. Cl. 705/1; 705/8

(57) ABSTRACT

A method for the assigning rack space in an Internet data center is disclosed. The method includes defining a fragment space from the rack space and defining a fragment space threshold. When a business requesting a rack space is received, a space from the fragment space is assigned to the business if it is determined that the size of space requested by the business is smaller than the fragment space threshold.

### FIELD OF THE INVENTION

The present invention relates generally to techniques of space assignment, and more specifically, to a method and apparatus for automatic rack space assignment in an Internet Data Center.

### BACKGROUND OF THE INVENTION

An Internet data center normally includes racks for hosting customer devices. Each rack has rack space in which the customer devices (i.e., data) are stored. The customer devices, commonly referred to as businesses, need to be stored in a continuous free rack space. When a new business request occurs, it is required to query whether there is any continuous free space available in the current rack space which is larger than the space required by this business. If there is enough continuous free space, the business is accepted.

Rack space is an expensive and scarce resource. Normally, the unit for rack space size is indicated by Unit Space U. Generally, a medium-sized Internet data center has a rack space of 200 (the number of individual racks)*40 (the unit space in a single rack)=8000 U=8 KU. Therefore, rack space is a valuable resource in the Internet data center, and has to be utilized efficiently.

However, like other space assignment schemes such as hard disk assignment scheme and memory allocation scheme in computers, the assignment of rack space will also encounter fragmentation issues. Fragments in rack space are generated by repeatedly allocating and releasing rack spaces, and affects the overall performance of the Internet data centre. The amount of fragments is directly related to an assignment algorithm used for allocating rack spaces. A large amount of fragments greatly reduces the amount of continuous free space in rack space, resulting in a new business request not been able to be accepted even when there is sufficient overall free space.

For example, refer to FIG. 1 in which two racks are shown. Both Rack A and B have an overall space of 30 U each, but have different space utilization.

For rack A, there is a total free space of 6 U. The free space in rack A is divided into four parts: 1 U, 1 U, 2 U, 2 U. For rack B, there is also a total free space of 6 U. The free space of rack B is divided into two parts: 5 U and 1 U. When a business request of 4 U occurs, Rack A, even though having a total free space of 6 U, cannot accept this business request because there is no continuous free space which exceeds 4 U. On the other hand, rack B can accept this business request because it has a continuous free space of 5 U (which exceeds 4 U).

It can be seen that because of the existence of large amount of fragments (any continuous space smaller than 4 U is regarded as fragment for a 4 U business), rack A is unable to accept the business request even though it has enough overall free space. In this case, Rack A can only accept business request which is smaller than 2 U. If there is no business which is smaller than 2 U, the free space in rack A will be left unused. This is a great waste of valuable rack space.

FIG. 2A shows a continuous free space of 10 U. In this example, a new business requests a 1 U space. If the 1 U business request is inappropriately assigned in the 10 U continuous rack space, fragments may be generated.

For example, the 1 U business request may be assigned to a 1 U space in the middle of the continuous 10 U rack space as shown in FIG. 2B. This generates two spaces of 4 U and 5 U, respectively. Thus, the rack can now only accept new business requests that are 5 U or smaller despite having a total free rack space of 9 U.

In another example, the 1 U business request is assigned to a 1 U space at one end of the continuous 10 U rack space as shown in FIG. 2C. In this case, the rack, having a total free space of 9 U, is also able to accept a business request of 9 U. Accordingly, an efficient utilization of free rack space is achieved.

As can be seen from the examples above, a large amount of fragments may be generated using inappropriate assignment methods, resulting in degradation of the performance of the Internet data centre. Although fragmentation also occurs in computer hard disk space assignment or memory space assignment, they do not manifest into the problems seen in Internet data center.

FIG. 3A shows a 30 U space in a computer hard disk or memory (for ease of description, the Unit Space U is also used as a unit of measure for computer hard disk space or memory space). The space utilization is as follows: 1 U free space; 11 U occupied space; 1 U free space; 5 U occupied space; 2 U free space; 5 U occupied space; 2 U free space; 3 U occupied space. When there is a 5 U business request, the space in the computer hard disk or memory can be adjusted and the free space can be merged to form a continuous free space. In FIG. 3B, a 6 U continuous free space is formed as a result of such a space adjustment. In computer hard disk space or memory space, such space adjustment is possible because the underlying physical space is transparent to the users, and the adjustment of storage location does not affect the use of these data.

However, the above method of space adjustment is not available for rack space in Internet data center because:

1) It is the customer device (i.e., data) that is stored in the rack space of the Internet data center. Every change of storage space corresponds to a physical relocation of the device. Since there are many customers, it would be almost impossible for all the customers to relocate their respective devices stored at various locations, and to modify the devices' corresponding settings each time a new business request is received;

2) The rack space of the Internet data center is a space open to the customers rather than an internal space, such as computer hard disk space or memory space, available only to systems. Frequent modification of such open space is normally not acceptable to the customers.

Therefore, as compared to other space assignment schemes, rack space assignment has an important difference: the assigned space can only be released but not moved or modified by merging.

Therefore, it is desirable to reduce the generation of fragments and to maintain a continuous free space which is as large as possible.

### SUMMARY

A method for the assigning rack space in an Internet data center is disclosed. The method includes defining a fragment space from the rack space and defining a fragment space threshold. When a business requesting a rack space is received, a space from the fragment space is assigned to the business if it is determined that the size of space requested by the business is smaller than the fragment space threshold.

### BRIEF DESCRIPTION OF DRAWINGS

The embodiments of the invention will be better understood in view of the following drawings and the detailed description.

FIG. 1 shows two examples of rack space utilization which results in fragments being generated.

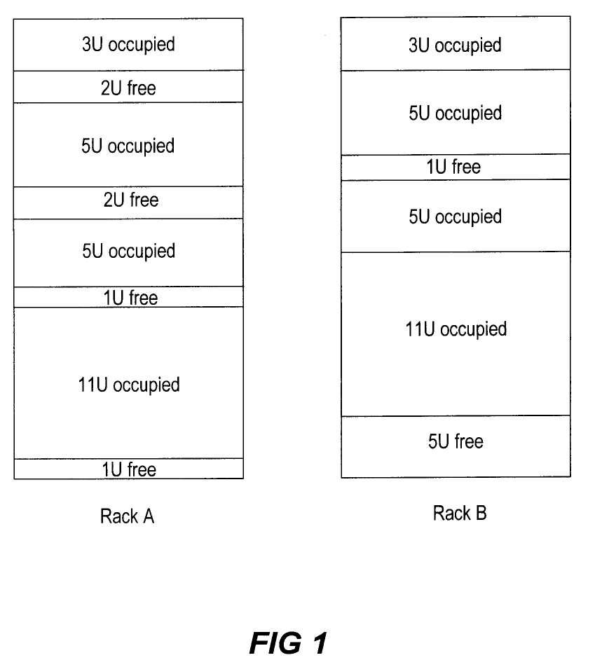

FIGS. 2A-2C show the generation of fragments based on different assignments of free space to a business request.

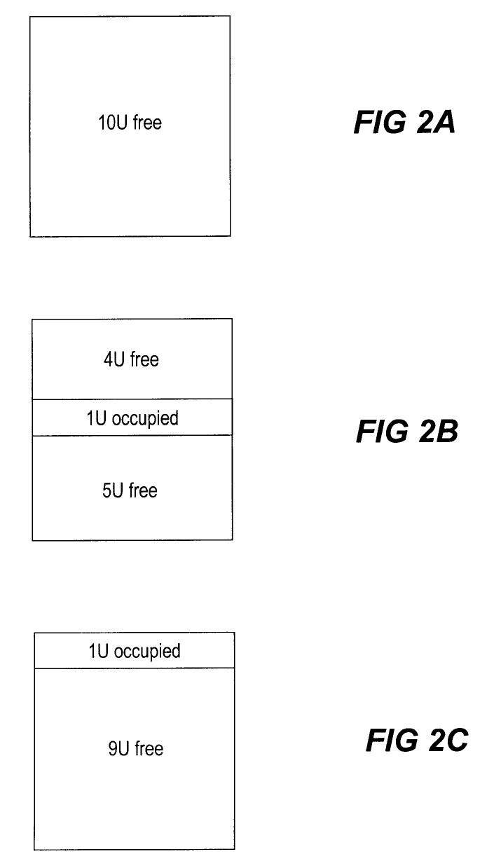

FIGS. 3A and 3B show an example of fragment eliminating method in other space assignments;

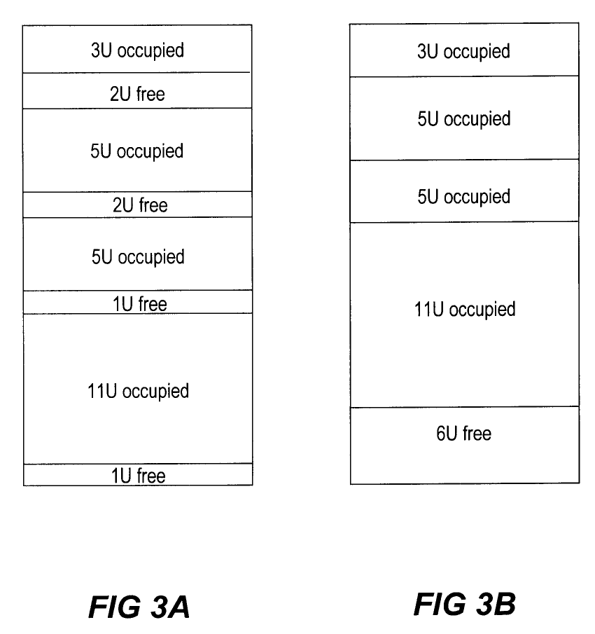

FIG. 4 shows a flow chart of a rack space assignment method according to a first embodiment.

FIGS. 5A-5D show the assignment status of rack space after the free space is assigned using the rack space assignment method according to the first embodiment.

FIG. 6 shows a flow chart of a rack space assignment method according to a second embodiment.

FIGS. 7A-7D show the assignment status of rack space after the free space is assigned using the rack space assignment method according to the second embodiment.

FIG. 8 shows a flow chart of a rack space assignment method according to a third embodiment.

FIG. 9 shows a flow chart of a rack assignment algorithm.

FIG. 10 shows a flow chart of a weight calculation algorithm according to an embodiment.

FIG. 11 shows an architecture diagram of a rack space assignment system according to an embodiment.

### DETAILED DESCRIPTION OF THE EMBODIMENTS

### First Embodiment

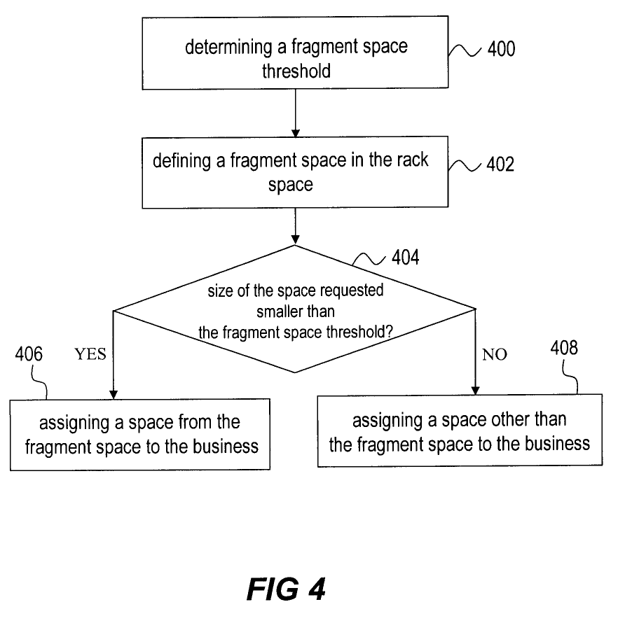

With reference to FIG. 4, a flow chart of a rack space assignment method for Internet data center according to a first embodiment is shown. Step 400 includes determining a fragment space threshold. Step 402 includes defining a fragment space in the rack space. Step 404 includes, upon receiving a business request for a rack space, determining whether the size of the space requested by the business is smaller than the fragment space threshold. If the size of the requested space is smaller than the fragment space threshold, then space is assigned from the fragment space to the business (Step 406). If the size of the requested space is larger than the fragment space threshold, then space is assigned to the business from spaces other than the fragment space (Step 408).

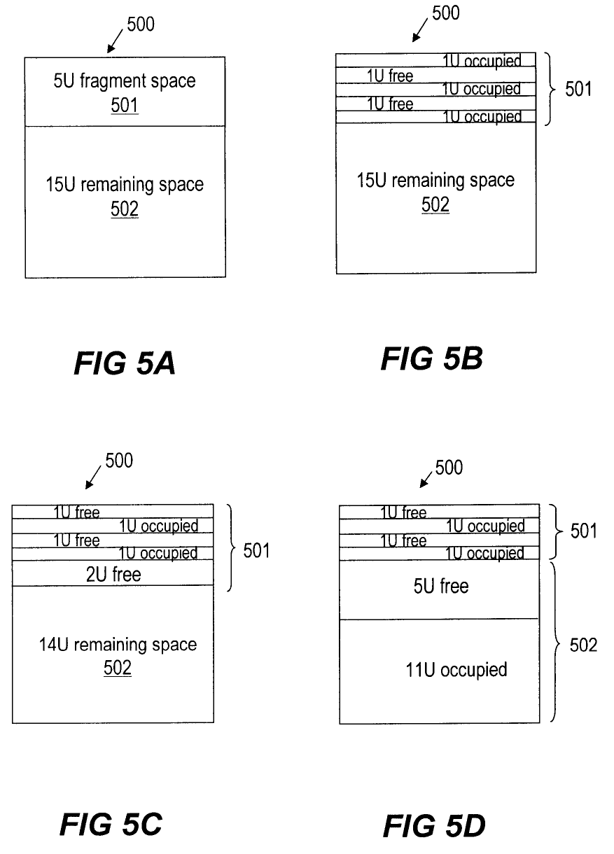

FIGS. 5A-5D show an example of the assignment status of rack space after the free space is assigned using the rack space assignment method according to the first embodiment. In FIG. 5A, a rack space 500 of 20 U is divided into two parts: a fragment space 501 of 5 U and a remaining space 502 of 15 U. According to an embodiment, the fragment space threshold is set as 2 U. In other words, any business request that is smaller than 2 U will be placed into the fragment space 501 of 5 U, while any business request that is larger than 2 U will be placed into the remaining space 502 of 15 U. For business request that is exactly 2 U, it can be placed into either one of the spaces 501, 502. It should be noted that the fragment space threshold is set according to practical space utilization constrains, and the invention is not limited to the fragmented space threshold being set at 2 U.

Normally, after the assignment of one space, the fragment space threshold is reset and the fragment space is re-defined. For example in FIG. 5B, there are three 1 U spaces in the 5 U fragment space 501 that are occupied. At this time, the largest continuous free space in the fragment space 501 becomes 1 U. Therefore, the fragment space threshold needs to be reset as 1 U.

After a new business request is received and space is assigned from rack space, the fragment space may also be re-defined. For example, with reference to FIG. 5C, there are two 1 U spaces in the 5 U fragment space 501 that are occupied, and the largest continuous free space in the fragment space 501 becomes 1 U. At this stage, the size of the fragment space 501 may be changed if it is desired to maintain the fragment space threshold at 2 U. Accordingly, the size of the fragment space 501 may be changed to 6 U as shown in FIG. 5C so as to maintain the size of largest continuous space in the fragment space 501 to be at 2 U.

Sometimes, it may be necessary to adjust the fragment space threshold and to re-define the fragment space simultaneously. For example in FIG. 5D, two 1 U spaces in the fragment space 501 and one 11 U space in the 15 U remaining space 502 are occupied. At this stage, the remaining space 502 may be enlarged to 16 U if the rack needs to accept a business request of 5 U. In this manner, since the largest continuous free space in the fragment space 501 becomes 1 U, the fragment space threshold is changed to 1 U.

### Second Embodiment

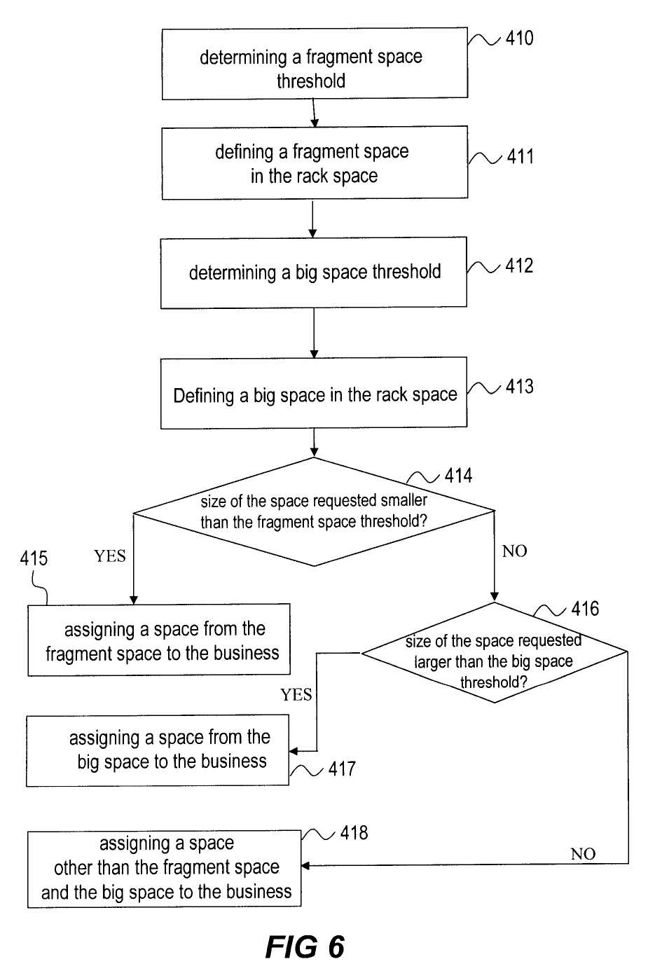

With reference to FIG. 6, a flow chart of the rack space assignment method for Internet data center according to a second embodiment is shown. Step 410 includes determining the fragment space threshold. Step 411 includes defining the fragment space in the rack space. Step 412 includes determining a big space threshold. Step 413 includes defining a big space in the rack space, the big space not overlapping with the fragment space. Step 414 includes, upon receiving a business requesting a rack space, determining whether the size of the space requested by the business is smaller than the fragment space threshold. If the size of the space requested by the business is smaller than the fragment space threshold, a space is assigned to the business from the fragment space (Step 415). If the size of the space requested by the business is larger than the fragment space threshold, then it is further determined whether the size of the space requested by the business is larger than the big space threshold in Step 416. If the size of the space requested by the business is larger than the big space threshold, then a space is assigned to the business from the big space in Step 417. If the space requested by the business is smaller than the big space threshold, then a space from spaces other than the fragment space and the big space is assigned to the business in Step 418.

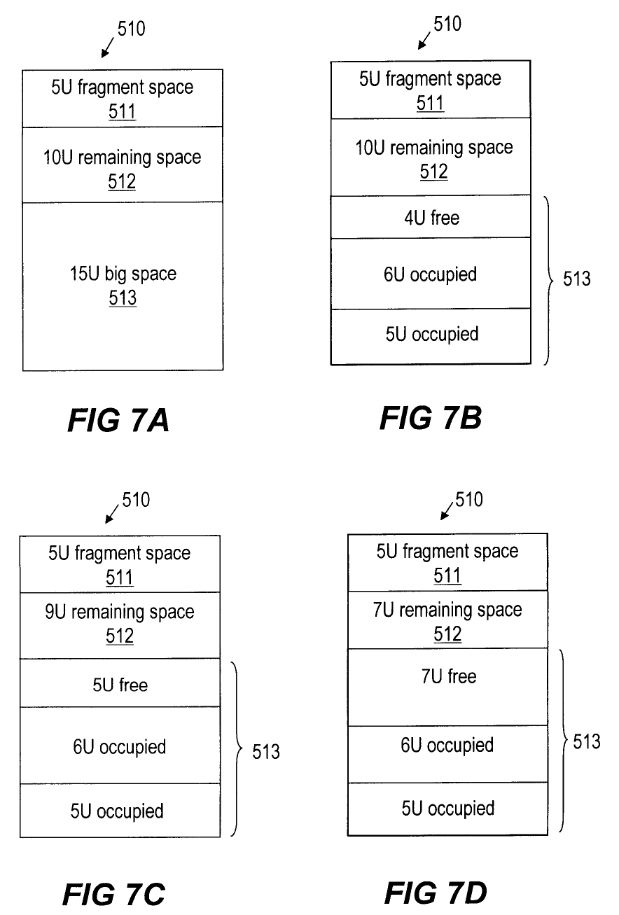

FIG. 7A-7D shows an example of the assignment status of the rack space after the free space is assigned according to the method of FIG. 6. In FIG. 7A, a rack space 510 of 30 U is divided into three parts: a fragment space 511 of 5 U, a remaining space 512 of 10 U, and a big space 513 of 15 U. According to the utilization, the fragment space threshold is set as 2 U. In other words, any business request that is smaller than 2 U will be placed into the fragment space 511 of 5 U. The big space threshold is set as 5 U. In other words, any business request that is larger than 5 U will be placed into the big space 513 of 15 U. Business requests that are larger than 2 U but smaller than 5 U will be placed into the remaining space 512 of 10 U. For business request that is exactly 2 U or 5 U, it can be placed into any one of the three spaces as discussed above. Similarly, the sizes of the three spaces are set according to practical space utilization, and the invention is not limited to the sizes set in this example.

After one space assignment, it may be needed to reset the big space threshold and re-define the big space. For example in FIG. 7B, there are one 6 U space and one 5 U space in the 15 U big space 513 that are occupied. Accordingly, the largest continuous free space in the big space 513 becomes 4 U. Thus, the big space threshold is reset to 4 U.

Every time a new business is received and space from the rack space is assigned, the big space may also be re-defined. For example in FIG. 7C, the size of the big space 513 may be changed if it is desired to maintain the big space threshold at 5 U. For example in FIG. 7C, the size of the big space 513 is changed to 16 U so as to maintain the size of the largest continuous free space in the big space 513 at 5 U. Accordingly, the size of the remaining space is changed to 9 U.

It may be needed to simultaneously re-determine the big space threshold and re-define the big space in some embodiments. For example in FIG. 7C, there are one 6 U space and one 5 U space in the big space 513 that are occupied. If it is desired for the rack to accept a business request of 7 U, the big space 513 needs to be enlarged to 18 U. Accordingly, the big space threshold is adjusted to 7 U, and the size of the remaining space is reduced to 7 U as shown in FIG. 7D.

It should be obvious to a person skilled in the art that in some cases, adjustments to parameters of the big space may affect the parameters of the fragment space. Therefore, it may be necessary to adjust the parameters of both the big space and the fragment space simultaneously. For example in FIG. 7D, if it is desired to maintain the remaining space at 10 U, the size of the fragment space has to be adjusted. In combination with the utilization of the fragment space, the fragment threshold may also be adjusted as evident to the person skilled in the art.

### Third Embodiment

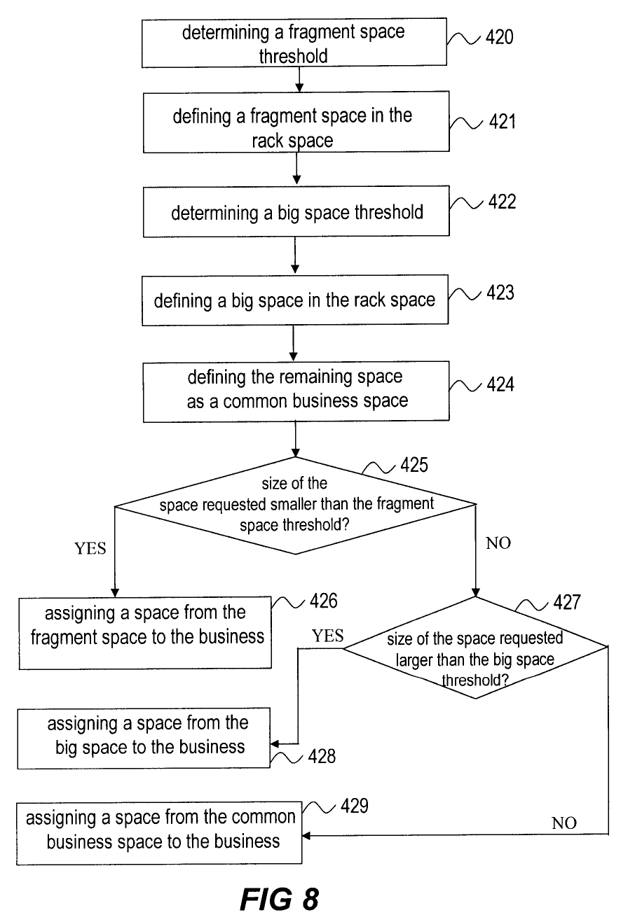

With reference to FIG. 8, a flow chart of the rack space assignment method for Internet data center according to a third embodiment is shown. Step 420 includes determining the fragment space threshold Step 421 includes defining the fragment space in the rack space. Step 422 includes determining the big space threshold. Step 423 includes defining the big space in the rack space, the big space not overlapping with the fragment space. Step 424 includes defining the remaining space as a common business space.

Step 425 includes, upon receiving a business requesting a rack space, determining whether the size of the space requested by the business is smaller than the fragment space threshold. If the space requested by the business is smaller than the fragment space threshold, step 426 includes assigning a space from the fragment space to the business. If the space requested by the business is larger than the fragment space threshold, step 427 includes further determining whether the size of the space requested by the business is larger than the big space threshold. If the size of the space requested by the business is larger than the big space threshold, step 428 includes assigning a space from the big space to the business. If the space requested by the business is smaller than the big space threshold, step 429 includes assigning a space from the common business space to the business.

The flow and the space assignment status in this embodiment is similar to that in the second embodiment described above, and hence will not be repeated. It is to be noted that the fragment space, the big space, and the common business space are generally contiguous spaces. In other words, the three spaces are arranged together to form a single continuous space. However, the order of the three spaces in the contiguous space in the present invention is not limited to the embodiments described herein.

Rack Space Assignment Algorithm in Dividing Racks

A typical Internet data center normally includes several racks, each rack having a corresponding rack space. When there is a business request, the rack space assigned to the business is selected from a most appropriate rack among the several racks of the data centre. The general assignment principle has already been described above. An exemplary assignment algorithm will now be described below.

A series of objects are defined: a first object for indicating a single rack, and a second object for indicating a continuous free space in the single rack. In this example, the first object is defined as Rack and the second object is defined as RackRoom.

The second object further comprises two sub objects: a first sub object for indicating a weight of the continuous free space in the single rack, and a second sub object for indicating a size of the continuous free space in the single rack. The first sub object is defined as iWeight, and the second sub object is defined as iSpace.

In this example, a third object is further defined to indicate the size of a unit space in the rack space, i.e., the size of one U. Since U is not a standard space unit, this object specifies an actual size of one U. The third object is defined as RackSpace.

In addition, a series of parameters are defined:

fragment space threshold (FSH);

big space threshold (BSH);

fragment space area (FSA), which indicates the range of the fragment space;

the size of the space requested by the business, represented using iNeedSpace.

A big space area is not defined. It is obvious to a person skilled in the art that if a parameter for big space area is added, the above algorithm may also be implemented.

The following descriptions are directed to the above three parameters.

Upon receiving a new business request, a new iWeight value (i.e., the weight of a continuous free space in a single rack) is calculated based on a current value of Rack, a current value of iWeight, a current value of Space, iNeedSpace, BSH, FSH, and FSA.

When assigning a space, the assigned space shall satisfy the following conditions:

the space having the largest iWeight, i.e., largest weight; and

the space having an iSpace which is not smaller than iNeedSpace, i.e., a continuous free space.

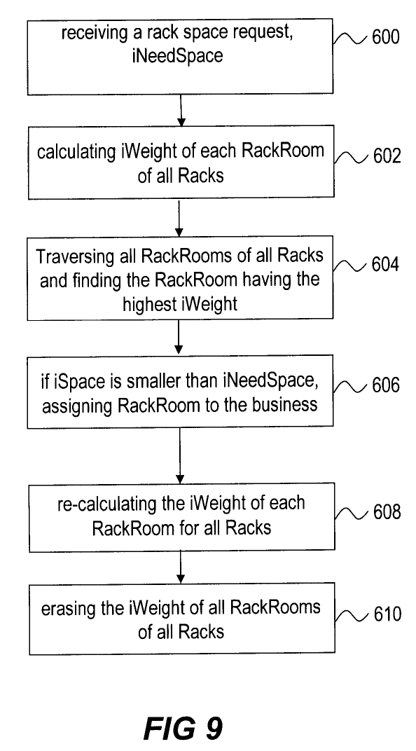

FIG. 9 shows a flow chart of a rack assignment algorithm according to an embodiment. Step 600 includes receiving a rack space, iNeedSpace, requested by the business. Step 602 includes calculating the weight of all continuous spaces in all single rack, that is, for all Rack, calculating iWeight of each RackRoom. Step 604 includes finding from all continuous spaces of all single racks, the one having the highest weight. In other words, traversing all RackRoom of all Rack and finding the one having the largest iWeight.

If the iSpace of the RackRoom is smaller than the iNeedSpace, this continuous space is assigned to the business (Step 606). After assignment, Step 608 includes re-calculating the weight of all continuous spaces in all single rack, that is, for all Rack, re-calculating the iWeight of each RackRoom. Step 610 includes erasing all weights after completing the procedures, that is, erasing the iWeight for all RackRoom in all Rack.

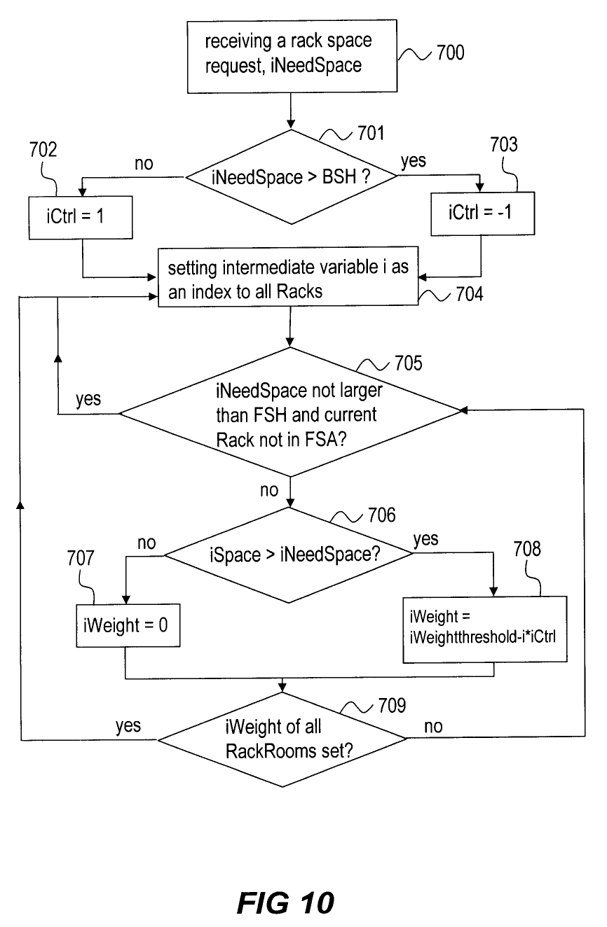

FIG. 10 shows a flow chart of a method of a weight calculation algorithm according to an embodiment. Step 700 includes receiving a rack space request from the business, iNeedSpace. Step 701 includes determining the size of iNeedSpace and BSH. If iNeedSpace is smaller than BSH, an intermediate variable iCtrl is set to 1 in Step 702. If iNeedSpace is larger than BSH, the intermediate variable iCtrl is set to −1.

Step 704 includes setting an intermediate variable i, and using i as an index for all Rack. Step 705 includes determining whether the following conditions are satisfied:
the current Rack is not in FSA; and
iNeedSpace is not larger than FSH.

### If the above conditions are satisfied, the index value i is changed (Step 704), and the next Rack is inquired again in Step 705 whether it satisfies the two conditions, until a Rack not meeting the conditions is found.

Step 706 includes determining whether the iSpace of this RackRoom is larger than iNeedSpace for all RackRoom in this Rack. If iSpace is smaller than iNeedSpace, the Weight of this RackRoom is set to 0 in Step 707. If iSpace is larger than iNeedSpace, the iWeight of this RackRoom is set to iWeightthreshold−i*iCtrl, wherein iWeightthreshold is a predetermined variable value and is generally set to a constant to ensure iWeight is always larger than 0.

Step 709 includes determining whether Weight has been set for all RackRoom in this Rack. If iWeight has not been set for all RackRoom, the method returns to Step 705 to calculate iWeight for a next RackRoom in the Rack. If iWeight for all RackRoom in the Rack has been calculated, the method returns to Step 704 to find a next Rack.

After iWeight has been set for all Rack and the RackRoom, the RackRoom having the highest iWeight is found after traversing all RackRoom in all Rack, and it is determined that the iSpace of this RackRoom is larger than iNeedSpace, then the assignment according to the embodiment is performed.

In the above algorithm, for RackRooms with iSpace larger than iNeedSpace, their iWeights are always larger than those RackRooms with iSpace smaller than or equal to iNeedSpace.

With the above algorithm, business requesting a small space may be limited in FSA to ensure there is enough continuous space for use by business requesting a larger space.

Exemplary Rack Space Assignment Apparatus

### First Embodiment

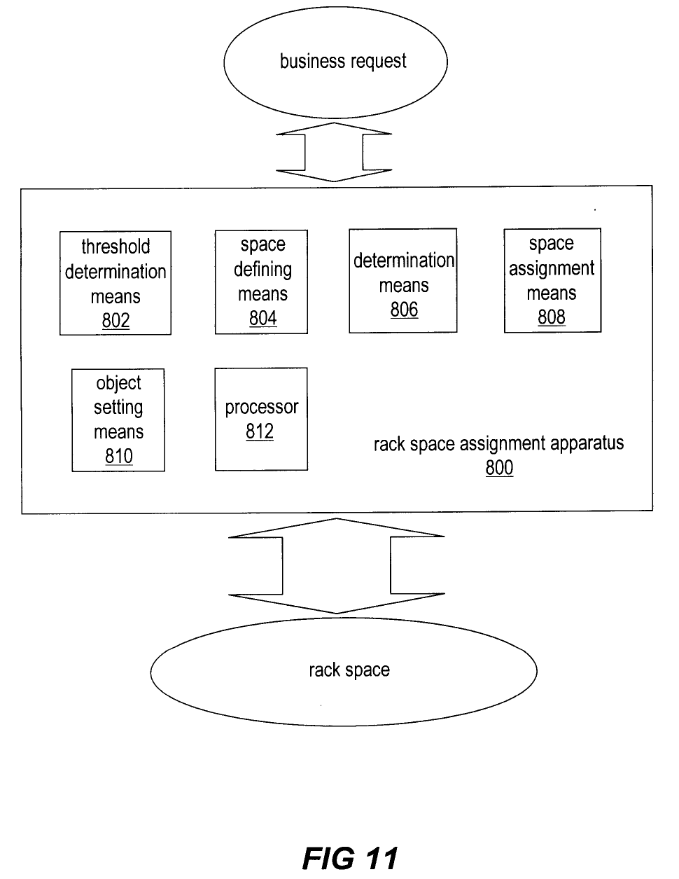

FIG. 11 shows a system diagram of a rack space assignment apparatus according to an embodiment. The apparatus 800 comprises a threshold determination means 802 for determining a fragment space threshold, a space defining means 804 for defining a fragment space in the rack space, a determination means 806 for determining the size of space requested by the received business; and a space assignment means 808 for assigning space to the business.

Upon receiving a business requesting a rack space, the determination means 806 first determines whether the size of space requested by the business is smaller than the fragment space threshold set by the threshold determination means 802. If it is smaller than the fragment space threshold, then the space assignment means 808 assigns a space from the fragment space to the business.

The functions of the space assignment means 808 in the first embodiment correspond to the rack space assigning method of the first embodiment, and their specific functions and space assignment examples has already been described above with reference to FIGS. 5A-5D.

Also, in accordance with the first embodiment, the threshold determination means 802 re-determines a fragment space threshold after receiving a new business and assigning space from the rack space. And the space defining means 804 re-defines a fragment space after receiving a new business and assigning space from the rack space.

### Second Embodiment

The system diagram of the second embodiment is also made with reference to FIG. 8. The apparatus 800 comprises the threshold determination means 802 for determining a fragment space threshold, the space defining means 804 for defining a fragment space in the rack space and a big space in the rack space, the big space not overlapping with the fragment space, the determination means 806 for determining the size of space requested by the received business, and the space assignment means 808 for assigning space to the business.

Upon receiving a business requesting a rack space, the determination means 806 determines whether the size of space requested by the business is smaller than the fragment space threshold set by the threshold determination means 802. If it is smaller than the fragment space threshold, the space assignment means 808 assigns a space from the fragment space to the business.

If it is not smaller than the fragment space threshold, the determination means 806 further determines whether the size of space requested by the business is larger than the big space threshold set by the threshold determination means 802. If it is larger than the big space threshold, then the space assignment means 808 assigns a space from the big space to the business.

The functions of the space assignment means 808 in the second embodiment correspond to the rack space assigning method of the second embodiment, and their specific functions and space assignment examples have already been described earlier with reference to FIGS. 7A-7D.

Also, in accordance with the first embodiment, the threshold determination means 802 re-determines a big space threshold after receiving a new business and assigning space from the rack space. The space defining means 804 re-defines a big space after receiving a new business and assigning space from the rack space. Similarly, in the apparatus of the second embodiment, the threshold determination means 802 may simultaneously adjust the fragment space threshold and the big space threshold, while the space defining means 804 may simultaneously adjust the fragment space and the big space.

### Third Embodiment

The system diagram of the second embodiment is also made with reference to FIG. 8. The apparatus 800 comprises the threshold determination means 802 for determining a fragment space threshold and a big space threshold, the space defining means 804 for defining a fragment space in the rack space and a big space in the rack space, the big space not overlapping with the fragment space, and also for setting the space in the rack space other than the fragment space and the big space as a common business space, the determination means 806 for determining the size of space requested by the received business; and the space assignment means 808 for assigning space to the business.

Upon receiving a business requesting a rack space, the determination means 806 first determines whether the size of space requested by the business is smaller than the fragment space threshold set by the threshold determination means 802. If it is smaller than the fragment space threshold, then the space assignment means 808 assigns a space from the fragment space to the business.

If it is not smaller than the fragment space threshold, the determination means 806 further determines whether the size of space requested by the business is larger than the big space threshold set by the threshold determination means 802. If it is larger than the big space threshold, then the space assignment means 808 assigns a space from the big space to the business. When it is determined by the determination means 806 that the size of space requested by the business is smaller than the big space threshold but larger than the fragment space threshold, then a space is assigned from the common business space to the business.

In the above three embodiments, the space defining means 804 defines the fragment space, the big space, and the common business space in such a manner that they form a single contiguous space.

In an embodiment, the system diagram of FIG. 8 further comprises an object setting means 810 for setting: a first object for indicating a single rack and is defined as Rack, and a second object for indicating a continuous free space in a single rack and is defined as RackRoom.

The second object further comprises two sub objects: a first sub object for indicating the weight of the continuous free space in the single rack and is indicated as iWeight, and a second sub object for indicating the size of the continuous free space in the single rack and is indicated as iSpace.

The object setting means 810 also comprise a third object for indicating the size of a unit space, i.e., the size of one U. Since U is not a standard space unit, this object specifies an actual size of one U. The third object is defined as RackSpace.

In addition, the object setting means 810 further defines a series of parameters, comprising:

fragment space threshold (FSH);

big space threshold (BSH);

fragment space area (FSA) for indicating the range of the fragment space;

the size of the space requested by the business, iNeedSpace.

A big space area is not defined. However, it is obvious to a person skilled in the art that if a parameter for big space area is added, the above algorithm may also be implemented.

Upon receiving a new business request, a new iWeight value (i.e., the weight of a continuous free space in a single rack) may be calculated based on a current value of Rack, a current value of iWeight, a current value of iSpace, iNeedSpace, BSH, FSH and FSA.

When assigning a space, the space assignment means 808 assigns spaces in accordance with the following conditions:

the space having a largest iWeight, i.e., largest weight;

the space having an iSpace not smaller than iNeedSpace, i.e., a continuous free space.

The determination means 806 and space defining means 808 in the above assignment apparatus 800 together implement the following functional steps in an embodiment. Alternatively, a processor 812 may be added into the assignment apparatus 800 in an alternative embodiment to implement the following:

receiving a rack space iNeedSpace requested by the business;

calculating the weight of all continuous spaces in all single rack, that is, calculating iWeight of each RackRoom for all Racks;

finding, from all continuous spaces of all single racks, the continuous space having the highest weight, that is, traversing all RackRooms of all Racks and finding the RackRoom having the highest iWeight;

if the iSpace of the RackRoom is smaller than iNeedSpace, then the continuous space is assigned to the business;

after assignment, re-calculating the weight of all continuous spaces in all single racks, that is, re-calculating the iWeight of each RackRoom for all Racks; and

after completing all procedures, erasing all weights, that is, erasing the iWeight for all RackRooms in all Racks.

The weight calculation algorithm receives a rack space requested by the business iNeedSpace, and determines the size of iNeedSpace and BSH. If iNeedSpace is larger than BSH, an intermediate variable iCtrl is set as −1. If iNeedSpace is not larger than BSH, the intermediate variable iCtrl is set as 1.

Another intermediate variable i is set, and is used as an index for all Racks. Two conditions are determined if they are satisfied: the current Rack is not in FSA and iNeedSpace is not larger than FSH. If these two conditions are satisfied, the index value i is changed. The algorithm then inquires whether the next Rack satisfies these conditions, until a Rack which does not meet the two conditions is found.

The algorithm further determines whether the iSpace of this RackRoom is larger than iNeedSpace for all RackRoom in this Rack. If the iSpace is larger than iNeedSpace, the iWeight of this RackRoom is set to iWeightthreshold−i*iCtrl, wherein iWeightthreshold is a predetermined variable value and is generally set to a constant to ensure iWeight is always larger than 0. If the iSpace is not larger than iNeedSpace, iWeight is set to 0.

The algorithm then determines whether iWeight has been set for all RackRooms in this Rack. If iWeight has not been set for all RackRooms, the algorithm returns to calculate iWeight for a next RackRoom in the Rack. And if all RackRooms in the Rack have been calculated, the algorithm returns to find a next Rack.

After iWeight has been set for all Racks and the RackRooms, the RackRoom having the highest iWeight has been found after traversing all RackRoom in all Rack, and it is determined that the iSpace of this RackRoom is larger than iNeedSpace, then assignment according to the embodiment is performed.

In the above algorithm, for RackRooms whose iSpace are larger than iNeedSpace, their iWeights are always larger than those RackRooms whose iSpace is smaller than or equal to iNeedSpace.

From the above algorithm, the business requesting smaller space may be limited in FSA to ensure there is enough continuous space for use by business requesting larger space.

In accordance with the embodiments described above, the generation of fragments in the rack space is reduced. Also, the large continuous space in the rack space can be assigned and used by large business requests. Therefore, the overall utilization efficiency of rack space is increased and performance is improved.

The present invention is not intended to be limited to the embodiments shown herein. Various modifications to the embodiments described above will be readily apparent to those skilled in the art and the generic principles defined herein may be applied to other embodiments without departing from the spirit or scope of the invention.

What is claimed is:

1. A method for assigning rack space in an Internet data center, comprising:
defining a fragment space from the rack space; and
determining a fragment space threshold;
wherein when a business requesting a rack space is received, a space from the fragment space is assigned to the business if it is determined that the size of space requested by the business is smaller than the fragment space threshold.

2. The method of claim 1, further comprising:
re-determining the fragment space threshold after receiving a new business and assigning the space from the rack space to the new business.

3. The method of claim 1, further comprising:
re-defining the fragment space after receiving a new business and assigning the space from the rack space.

4. The method of claim 1, further comprising:
defining a big space in the rack space, the big space not overlapping with the fragment space; and
determining a big space threshold,
wherein when the business requesting the rack space is received, a space from the big space is assigned to the business if it is determined that the size of space requested by the business is larger than the big space threshold.

5. The method of claim 4, further comprising:
re-determining the big space threshold after receiving a new business and assigning the space from the rack space.

6. The method of claim 5, further comprising:
re-defining the big space after receiving a new business and assigning the space from the rack space.

7. The method of claim 4, further comprising:
defining a common business space in the rack space, the common business space not overlapping with the fragment space and the big space,
wherein when the business requesting the rack space is received, a space from the common business space is assigned to the business if it is determined that the size of space requested by the business is smaller than the big space threshold but is larger than the fragment space threshold.

8. The method of claim 7, wherein,
the fragment space, the big space, and the common business space are arranged together to form a single contiguous space.

9. The method of claim 7, wherein the rack space of the Internet data center is divided into several racks, the method further comprising:
defining a first object for indicating a single rack;
defining a second object for indicating a continuous free space in a single rack; and
upon receiving the business requesting the rack space, assigning the space to the business based on the first object, the second object, the size of the space requested by the business, the big space threshold, and the fragment space threshold.

10. The method of claim 9, further comprising:
defining a first sub object for the second object, the first sub object indicating the weight of the continuous free space in the single rack;
defining a second sub object for the second object, the second sub object indicating the size of the continuous free space in the single rack; and
upon receiving the business requesting the rack space, assigning the space to be assigned to the business based on the first object, the first sub object, the second sub object, the space requested by the business, the big space threshold, and the fragment space threshold.

11. The method of claim 10, further comprising:
determining a value of a new first sub object based on a current value of the first object, a current value of the first sub object, a current value of the second sub object, the size of the space requested by the business, the big space threshold, and the fragment space threshold.

12. The method of claim 11, wherein assigning the space comprises:
assigning a continuous space having the highest first sub object value and a second sub object value which is not smaller than the size of the space requested by the business.

13. The method of claim 12, further comprising:
defining a third object which indicates the size of a unit space in the rack space.

14. An apparatus for assigning rack space for an Internet data center, comprising:
a threshold determination means for determining a fragment space threshold;
a space defining means for defining a fragment space in the rack space;
a determination means for determining the size of space requested by a business; and
a space assignment means for assigning a space to the business;
wherein when a business requesting a rack space is received, the determination means determines whether the size of the space requested by the business is smaller than the fragment space threshold set by the threshold determination means, and if the size of the space requested by the business is smaller than the fragment space threshold, a space is assigned from the fragment space defined by the space defining means to the business.

15. The apparatus of claim 14, wherein the threshold determination means re-determines the fragment space threshold after receiving a new business and assigning space from the rack space.

16. The apparatus of claim 15, wherein the space defining means re-defines the fragment space after receiving a new business and assigning space from the rack space.

17. The apparatus of claim 14, wherein,
the threshold determination means further determines a big space threshold; and
the space defining means further defines a big space in the rack space, the big space not overlapping with the fragment space;
wherein when a business requesting a rack space is received, the determination means determines whether the size of space requested by the business is larger than the big space threshold set by the threshold determination means, and if size of space requested by the business is larger than the big space threshold, the space assignment means assigns a space from the big space defined by the space defining means to the business.

18. The apparatus of claim 17, wherein the threshold determination means re-determines a big space threshold after receiving a new business and assigning space from the rack space.

19. The apparatus of claim 18, wherein the space defining means re-defines a big space after receiving a new business and assigning space from the rack space.

20. The apparatus of claim 17, wherein the space defining means further defines a space in the rack space, other than the fragment space and the big space, as a common business space, wherein when the business requesting the rack space is received, a space from the common business space is assigned to the business if it is determined by the determination means that the size of the space requested by the business is smaller than the big space threshold but larger than the fragment space threshold.

21. The apparatus of claim 20, wherein the fragment space, the big space, and the common business space are defined by the space defining means in such a manner that they are arranged together to form a single contiguous space.

22. The apparatus of claim 21, wherein the rack space of the Internet data center is divided into several racks, the apparatus further comprises an object defining means for:
defining a first object for indicating a single rack;
defining a second object for indicating a continuous free space in a single rack;
wherein when the business requesting the rack space is received, the space assigned to the business is determined based on the first object, the second object, the size of the space requested by the business, the big space threshold, and the fragment space threshold.

23. The apparatus claim 22, wherein the object defining means further defines:
a first sub object for the second object, the first sub object indicating the weight of the continuous free space in the single rack; and
a second sub object for the second object, the second sub object indicating the size of the continuous free space in the single rack;
wherein when the business requesting the rack space is received, the space assigned to the business is determined based on the first object, the first sub object, the second sub object, the size of the space requested by the business, the big space threshold, and the fragment space threshold.

24. The apparatus of claim 23, further comprising a calculation means, wherein the calculation means determines a value of a new first sub object based on a current value of the first object, a current value of the first sub object, a current value of the second sub object, the space requested by the business, the big space threshold, and the fragment space threshold.

25. The apparatus of claim 24, further comprising a space assignment means for assigning to the business a continuous space having the highest first sub object value and the second sub object value not smaller than the space request by the business.

26. The apparatus of claim 25, wherein the object defining means further defines a third object for indicating the size of a unit space in the rack space.
